(19) United States
(12) Patent Application Publication
(10) Pub. No.: US 2008/0223629 A1
(43) Pub. Date: Sep. 18, 2008

(54) COORDINATE INPUT APPARATUS

(75) Inventors: Takahiro KASHIKAWA, Kawasaki (JP); Fumio TAKEI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kanagawa (JP)

(21) Appl. No.: 12/049,738

(22) Filed: Mar. 17, 2008

(30) Foreign Application Priority Data
Mar. 16, 2007 (JP) 2007-68749

(51) Int. Cl. G06F 3/041

(52) U.S. Cl. 178/18.03

(57) ABSTRACT

A coordinate input apparatus with a pair of conductive films which are arranged opposite to each other for identifying a coordinate by a contact therebetween, wherein at least one of the conductive films contains clay minerals.

### TECHNICAL FIELD

The present invention relates to a coordinate input apparatus.

### BACKGROUND

In recent years, the popularity and development of portable communication systems has introduced a coordinate input apparatus which has an excellent man-machine interface performance, which is now variously applied. Such an intelligent device has considerably contributed to the downsizing and multifunctionality of products based on the development of a semiconductor device. Especially, portable communication terminals such as a cell phone, a personal digital assistant (PDA), and a laptop computer could be remarkably downsized, resulting in that the volume ratio of input devices or display devices to the main body of the terminal is increased.

The coordinate input apparatus includes a pair of resistance films which individually have a transparent conductive film and are arranged so that the transparent conductive films are opposed to each other with a predetermined space provided therebetween, and an application of pressure to one of the resistance film causes the parts of the opposed transparent conductive films which corresponds to the pressurized position to be contacted and electrically conducted to each other. The resistance film is formed of an ITO transparent electrode which can be obtained by deposition of In and Sn, but Indium Tin Oxide (ITO) requires a high manufacturing cost. Also ITO causes a resistance of a resistance film to be changed by a continuous writing, thereby an accuracy of reading of a coordinate position is likely to be degraded. Alternatively, a coordinate input apparatus using an organic transparent conductive material is known, as disclosed in Japanese Patent Laid-Open No. 2006-127074 and Japanese Patent Laid-Open No. 2006-331243 for example.

The above described coordinate input apparatus uses an organic transparent conductive film in one or both of resistance films, which leads to another problem that a contact resistance value considerably changes and the input sensitivity of the apparatus is reduced and a time for inputting a coordinate is delayed.

When one of the resistance films uses an organic transparent conductive film and the other resistance film which functions as an opposed electrode uses a transparent conductive film formed of metal oxide which is different from the organic transparent conductive film, due to the different hardness of the materials of the resistance films which contact each other, continuous inputs at high loads cause the surface of the organic transparent conductive film to be flattened and considerably changes the contact resistance value, results in the problem of reduced input sensitivity and delayed time for inputting a coordinate.

To the contrary, when both of the resistance films use organic transparent conductive films, due to the high resistance value of the organic transparent conductive film, a contact resistance value between the resistance films is increased, results in the problem of reduced input sensitivity and delayed time for inputting a coordinate as in the above case.

### SUMMARY

A coordinate input apparatus of the present invention has a conductive film which contains clay minerals.

### BRIEF DESCRIPTION OF THE DRAWINGS

FIG. 1 is a schematic sectional view showing a structure of a resistance film of a touch panel included in a coordinate input apparatus according to an embodiment of the present invention;

FIG. 2 is a schematic perspective view showing a structure of a resistance film of a touch panel included in a coordinate input apparatus according to an embodiment of the present invention;

FIG. 3 is a schematic view showing a structure of a coordinate input apparatus according to an embodiment of the present invention;

FIG. 4 is a schematic sectional view showing a structure of a resistance film of a touch panel included in a coordinate input apparatus according to another embodiment of the present invention; and

FIG. 5 is a view showing results of the minimum input load in a coordinate input apparatus according to experiments of the present invention.

### DETAILED DESCRIPTION OF THE EMBODIMENTS

In the present invention, one or both of a pair of resistance films uses an organic transparent conductive film as a transparent conductive film, and at least one of the resistance film, that is the organic transparent conductive film, is added with clay minerals. The addition of the clay minerals imparts elasticity to the organic transparent conductive film, and also forms a fine concavo-convex structure on the surface of the film.

The organic transparent conductive film having the clay minerals added thereto is provided with the elasticity which allows the surface profile thereof to be quickly reconstructed even when the organic transparent conductive film is plastically deformed by a high load such as a continuous writing. In such a structure, especially in a case where one of the resistance films use an organic transparent conductive film with the clay minerals and the other resistance film which functions as an opposed electrode uses a transparent conductive film formed of metal oxide which is different from the organic transparent conductive film, when the resistance films which are formed of materials having different hardness contact each other, the quick reconstruction of the surface profile of the organic transparent conductive film inhibits a change of a contact resistance value. This improves the input sensitivity, and shortens the time for inputting a coordinate of the structure.

In the organic transparent conductive film having the clay minerals added thereto, the clay minerals form a fine concavo-convex structure on the surface of the organic transparent conductive film. In such a structure, especially in a case where both of the resistance films use an organic transparent conductive film with the clay minerals, when the resistance films having a high resistance value are arranged to oppose each other, electrical fields are concentratedly formed at the surface projections of the resistance film, and an apparent contact resistance value is decreased. This improves the input sensitivity, and shortens the time for inputting a coordinate of the structure.

Japanese Patent Laid-Open No. hei8-153646 discloses a ceramic condenser including an inner electrode which is formed by mixing the powder of layered clay minerals, a conductive polymer, and a solvent to introduce the conductive polymer between the layers of the clay minerals. Also, Japanese Patent Laid-Open No. hei8-279354 discloses an electrode of lithium secondary battery which includes a conductive polymer and an expansive layered clay compound. However, these documents were made to achieve the objects which are different from that of the present invention, and provide structures completely different from that of the present invention.

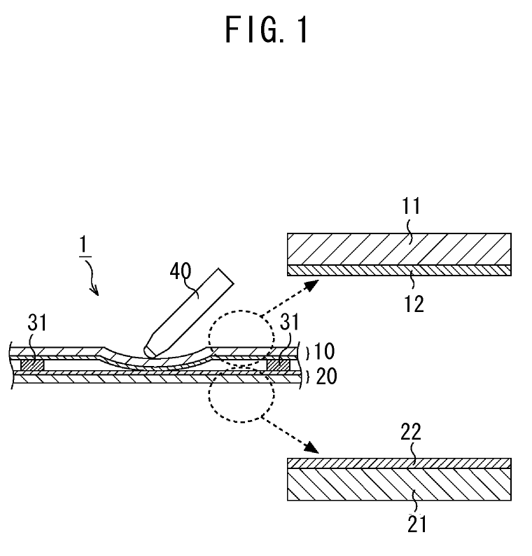

As shown in FIGS. 1 to 3, a coordinate input apparatus includes: a touch panel 1 to which a coordinate is input using a pen 40 for example; and a microcomputer (MCU) 51 for processing an electrical signal from the touch panel 1.

The touch panel 1 includes a transparent and flexible resistance film 10 having a transparent conductive film 12, a transparent and flexible resistance film 20 having a transparent conductive film 22, and the transparent conductive film 12 and the transparent conductive film 22 are opposed to each other with a predetermined space formed therebetween.

The resistance film 10 has the transparent conductive film 12 laminated on a transparent insulation substrate 11 which is a supporting substrate. The resistance film 20 has the transparent conductive film 22 laminated on a transparent insulation substrate 21 which is a supporting substrate. The term “transparent” as used herein means that the material absorbs little of a visible light (400 nm to 700 nm) and has a high transmittance.

The transparent insulation substrates 11 and 21 may be formed of a polymer including polyester based resin, acetate based resin, polyethersulphone based resin, polycarbonate based resin, polyamide based resin, polyimide based resin, polyolefin based resin, acrylic based resin, polyvinyl chloride based resin, polystyrene based resin, polyvinyl alcohol based resin, polyarylate based resin, polyphenylene sulfide based resin, polyvinylidene chloride based resin, and (meth)acrylic based resin. Glass can also be used.

The transparent insulation substrates 11 and 21 may be formed of a polyester base resin such as PET (polyethylene terephthalate) which absorbs ultraviolet rays having a wavelength 300 nm or less and has a high transmittance in a visible light region. The transparent insulation substrates 11 and 21 have a thickness on the order of 3 μm to 500 μm, preferably on the order of 5 μm to 300 μm, most preferably on the order of 10 μm to 200 μm, but the thickness is not limited to these, and the transparent insulation substrates 11 and 21 may have a various thickness depending on the application to use.

The transparent insulation substrates 11 and 21 may be formed of a resin which has an ultraviolet absorptivity. The ultraviolet absorptivity is obtained by internally adding an ultraviolet absorbing agent to the transparent insulation substrates 11 and 21. The internal addition of the ultraviolet absorbing agent improves the transmittance throughout the visible light range more than the case where a surface of the transparent insulation substrate 11 is subjected to a coating treatment for ultraviolet absorption. The ultraviolet absorbing agent may include inorganic ultraviolet absorbing agents such as titanium dioxide (TiO₂), zinc oxide (ZnO), tin oxide (SnO₂), cerium oxide (CeO₂), and an organic ultraviolet absorbing agent such as benzotriazole based compound, phenol based compound, benzene based compound, benzophenone based compound, triazine based compound, and cyanoacrylate based compound. The ultraviolet absorbing agent may be used alone or in combination of two or more types thereof.

The resin having an ultraviolet absorptivity described above can be manufactured by solving or suspending the resin used in the transparent insulation substrates 11 and 21 into an organic solvent such as Isopro and MEK (methyl ethyl ketone). The organic solvent may be, without any particular limitation, ketones such as methyl ethyl ketone and methyl isobutyl ketone, esters such as butyl acetate and ethyl acetate, and aromatic solvents such as xylene and toluene, aliphatic solvents, ether solvents, higher alcohol solvents such as ethylcelosolve, higher alcohol ester solvents such as cellosolve acetate, petroleum based solvents, and mineral spirits. In terms of durability, inorganic ultraviolet absorbing agents may be used as an ultraviolet absorbing agent, while in terms of transparency, organic ultraviolet absorbing agents may be used as an ultraviolet absorbing agent. Above all, in terms of durability, transparency, and resistance to fading, benzotriazole based compounds may be used as an ultraviolet absorbing agent. The content of the ultraviolet absorbing agent in a coating composition is preferably on the order of 2 wt % to 30 wt %, more preferably on the order of 5 wt % to 15 wt %. The ultraviolet absorbing agent within the above content range provides a coating film having an excellent weatherability, which inhibits the degradation of the transparent insulation substrates 11 and 21.

In an embodiment, the transparent conductive film 12 of the resistance film 10 is an organic transparent conductive film, and the organic transparent conductive film contains clay minerals.

The organic transparent conductive film preferably includes one or more materials selected from the group consisting of thiophene derivatives, polyaniline derivatives, and polypyrrole derivatives. For example, the organic transparent conductive film includes one or more material selected from the group consisting of polypyrrole, polythiophen, polyisothianaphthene, polyethylenedioxythiophene (PEDOT). Polyethylenedioxythiophene (PEDOT) has high transmittance and conductivity. PEDOT-PSS obtained by doping PEDOT with polystyrenesulphonate (PSS) has a higher conductivity.

The clay minerals contained in the organic transparent conductive film is preferably one or more types selected from the group consisting of montmorillonite, kaolinite, pyrophyllite, smectite, mica, chlorite, halloysite, allophane, imogolite, vermiculite, hectorite, gibbsitem and boehmite.

The content of the added clay minerals is preferably within a range of from 1 wt % to 70 wt % relative to a solid content concentration of the conductive film, more preferably within a range of from 5 wt % to 50 wt %. With the content of the clay minerals within a range of from 1 wt % to 70 wt %, the organic transparent conductive film 12 may have a proper surface resistivity, and a sufficient elasticity and surface profile.

In forming the transparent conductive film 12, an organic transparent conductive film which has the clay minerals dispersed in the above organic transparent conductive material is continuously coated on a surface of the transparent insulation substrate 1 to form a film having a thickness on the order of 100 nm to 500 nm for example using a wet coating method or the like, and then the film is heated and dried. The coating method may be a film formation method such as die coating, blade coating, gravure coating, and dip coating.

The material of the organic transparent conductive film may be added with a low molecular weight epoxy resin or a low molecular acrylic resin. In a case where a low molecular weight epoxy resin or a low molecular acrylic resin is added, the material of the organic transparent conductive film may be added with a silane coupling agent in addition to the above clay minerals. The added silane coupling agent improves the durability of the transparent conductive film 12 which is one of the elements of the resistance film 11 in the coordinate input apparatus.

The transparent conductive film 22 of the resistance film 20 is a transparent inorganic conductive film, and may be a metal oxide film such as SnO₂, In₂O₃, CdO, ZnO₂, SnO₂ with Sb, SnO₂ with F, ZnO with Al, and In₂O₃ with Sn. The transparent conductive film 22 may be a composite oxide film with a dopant such as an ITO film obtained by doping indium oxide with tin, FTO film obtained by doping tin oxide with fluorine, or IZO film of In₂O₃—ZnO amorphous. The transparent conductive film 22 may be formed by sputtering method, vacuum deposition, and ion plating, or a simple plasma discharge treatment at an atmosphere pressure. The transparent conductive film 22 preferably has a thickness on the order of 100 nm to 140 nm.

In the resistance films 10 and 20 configured as described above, the transparent conductive films 12 and 22 are adapted to have a contact resistance value of 10 kΩ or less. The contact resistance value is constrained to be 10 kΩ or less, so that a sufficient improvement of an input sensitivity and a sufficient shortening of a time for inputting a coordinate can be achieved.

In the touch panel 1, the resistance film 10 and the resistance film 20 are arranged opposite to each other in parallel via a frame spacer 30 formed of a transparent insulating material which is provided along edges of the resistance films 10 and 20. Thus, the resistance films 10 and 20 are arranged opposite to each other with a proper space being provided therebetween which is defined by the thickness of the frame spacer 30.

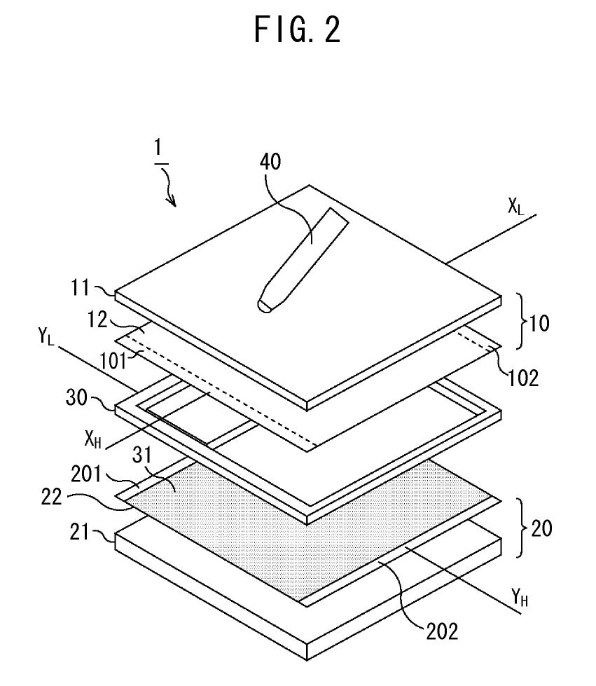

The transparent conductive film 12 or the transparent conductive film 22 has a number of fine granular dot spacers 31 formed thereon. FIG. 2 shows the case where the dot spacers 31 are formed on the transparent conductive film 22. The dot spacers 31 keeps the opposed transparent conductive films 12 and 22 separated from each other before use while no coordinate is input yet.

Furthermore, the transparent conductive film 12 is provided with electrodes 101 and 102 which are formed using conductive film strips and are bonded to opposite ends of the transparent conductive film 12 in parallel to each other, and similarly, the transparent conductive film 22 is provided with electrodes 201 and 202 which are bonded to opposite ends of the transparent conductive film 22 in parallel to each other. In use by inputting of a coordinate, the electrodes 101, 102, 201, and 202 send electrical signals which represent coordinate positions X_{H}, X_{L}, Y_{H}, and Y_{L} for example.

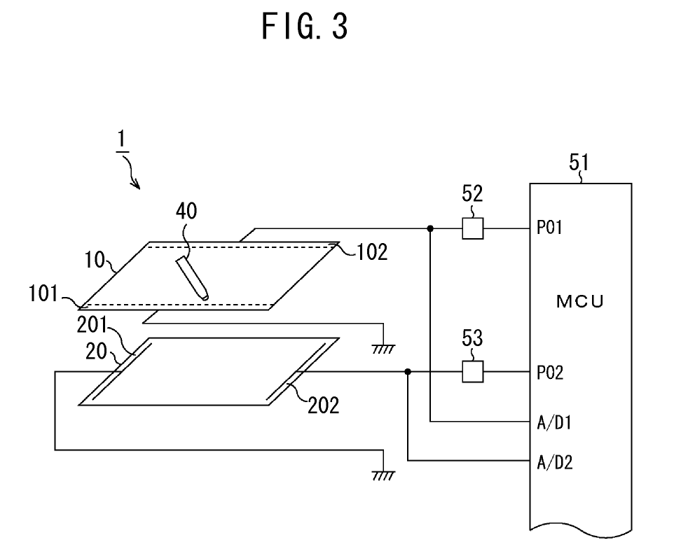

The resistance films 10 and 20 which form the touch panel 1 are, as shown in FIG. 3, electrically connected to a microcomputer (MCU) 51 for example that is a processor.

The MCU 51 is configured to include a port PO1 connected to a power source 52, a port PO2 connected to a power source 53, and converters A/D1 and A/D2. The electrode 102 of the resistance film 10 is connected to the port PO1 via the power source 52 and to the converters A/D1, and the electrode 202 of the resistance film 20 is connected to the port PO2 via the power source 53 and to the converters A/D2, and the electrode 101 of the resistance film 10 and the electrode 201 of the resistance film 20 are individually grounded. The electrical signals sent from the electrodes 101, 102, 201, and 202 are input to the MCU 51.

In use of the coordinate input apparatus, a predetermined part of a surface of the resistance film 10 is pressed down using a finger of an operator or a pen such as the pen 40 shown in FIG. 1 to FIG. 3, and the pressing causes the transparent conductive films 12 and 22 to contact each other to be electrically conducted at the contacted position. Then, the electrical signals which represent a coordinate for the contacted position are input through the electrodes 101, 102, 201, and 202 to the MCU 51, where the signals are appropriately processed so that the coordinate for the contacted position is input.

The operation of the coordinate input apparatus will be explained in more detail below.

Without any input operation by the pen 40, the transparent conductive film 12 of the resistance film 10 and the transparent conductive film 22 of the resistance film 20 remain separated by the dot spacer 31. In inputting a coordinate, a desired position on the resistance film 10 is pressed by the pen 40, so that the resistance film 10 is deformed at the pressed position to cause the transparent conductive film 12 and the transparent conductive film 22 to contact each other.

The resistance film 10 has the electrodes 101 and 102 formed on two opposite sides thereof, and between the electrodes 101 and 102, a reference voltage Vcc is applied at a constant period. Thus, at the contact point between the transparent conductive films 12 and 22, a voltage is produced by dividing the resistance of the transparent conductive film 12 between the electrodes 101 and 102. The divided voltage is detected as an electrical signal for representing a position coordinate as a voltage detected in the direction of the X-axis for example. When the electrical signal is processed at the MPU 51, the X coordinate of the contact point (pressurized position) can be input.

Similarly, the resistance film 20 has the electrodes 201 and 202 formed on two opposite sides thereof, and between the electrodes 201 and 202, a reference voltage Vcc is applied at a constant period. Thus, at the contact point between the transparent conductive films 12 and 22, a voltage is produced by dividing the resistance of the transparent conductive film 12 between the electrodes 201 and 202. The divided voltage is detected as an electrical signal for representing a position coordinate as a voltage detected in the direction of the Y-axis which is orthogonal to the X axis. When the electrical signal is processed at the MPU 51, the Y coordinate of the contact point (pressurized position) can be input.

In this way, the X and Y coordinates of the contact point (pressurized position) are input, thereby the pressurized position on the surface of the resistance film 20 can be identified.

As described above, according to an embodiment, a highly reliable coordinate input apparatus using resistance film is achieved in which flattening of the surface of the organic transparent conductive film 12 due to a high load input is prevented, and a change of the contact resistance value during a continuous writing is reduced, so that the input sensitivity is improved and a delay of time for inputting is inhibited.

A coordinate input apparatus of another embodiment of the present invention will be explained below. In a coordinate input apparatus, both of a pair of resistance films individually have an organic transparent conductive film.

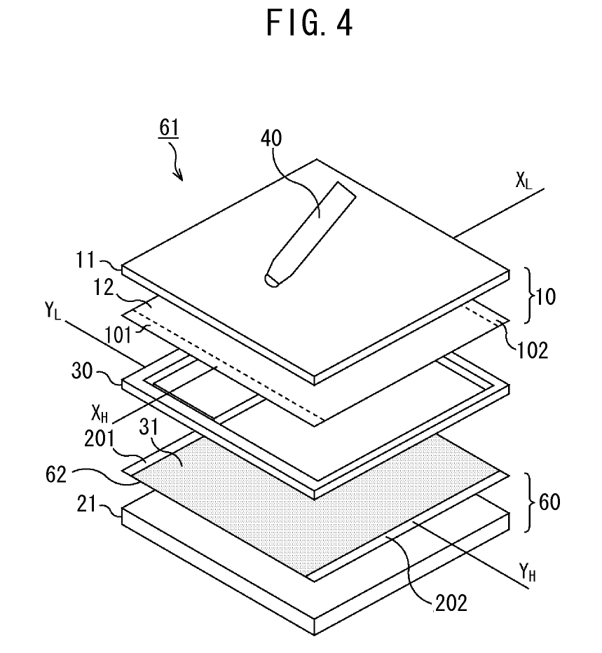

FIG. 4 is a schematic sectional view showing a structure of a resistance film of a touch panel included in a coordinate input apparatus according to another embodiment of the present invention.

In the coordinate input apparatus of another embodiment, a touch panel 61 is configured so that a resistance film 10 having a transparent conductive film 12 and a resistance film 60 having a transparent conductive film 62 are arranged to oppose the transparent conductive films 12 and 62 to each other with a predetermined space being provided therebetween.

In the coordinate input apparatus of another embodiment, similar to the transparent conductive film 12 of the resistance film 10, the transparent conductive film 62 of the resistance film 60 is formed of an organic transparent conductive film, and the organic transparent conductive film contains clay minerals.

The clay minerals contained in the organic transparent conductive film is preferably one or more types selected from the group consisting of montmorillonite, kaolinite, pyrophyllite, smectite, mica, chlorite, halloysite, allophane, imogolite, vermiculite, hectorite, gibbsitem and boehmite, similar to the transparent conductive film 12. The content of the added clay minerals is desirably within a range of from 1 wt % to 70 wt %, more preferably within a range of from 5 wt % to 50 wt %.

As described above, according to the coordinate input apparatus of another embodiment, a highly reliable coordinate input apparatus using resistance film is achieved in which flattening of the surface of the organic transparent conductive films 12 and 62 due to a high load input is prevented, and a change of the contact resistance value during a continuous writing is reduced, so that the input sensitivity is improved and a delay of time for inputting is inhibited.

These coordinate input apparatuses can be applied to electrical devices for inputting information by touching a screen using a pen or a finger to input data, such as electronic organizer, PDA (Personal Digital Assistants), cell phone, PHS, calculator, clock, GPS (Global Positioning System), ATM system for bank, automatic vending machine, and POS (Point Of Sales) system.

### (Experiment 1)

As to the resistance film 10, a thiophene based organic conductive film was used as the transparent conductive film 12 as shown in FIGS. 1 to 3, and montmorillonite was added as clay minerals to a content of 1 wt % relative to the solid content of the thiophene based organic conductive film. As to the resistance film 20, a glass sheet was used as the transparent insulation substrate 21, and an ITO film having a surface resistivity of 400 Ω/sq is formed on a surface of the glass sheet as the transparent conductive film 22 as shown in FIGS. 1 to 3. In this way, a touch panel 1 such as that shown in FIGS. 1 to 3 for example was made.

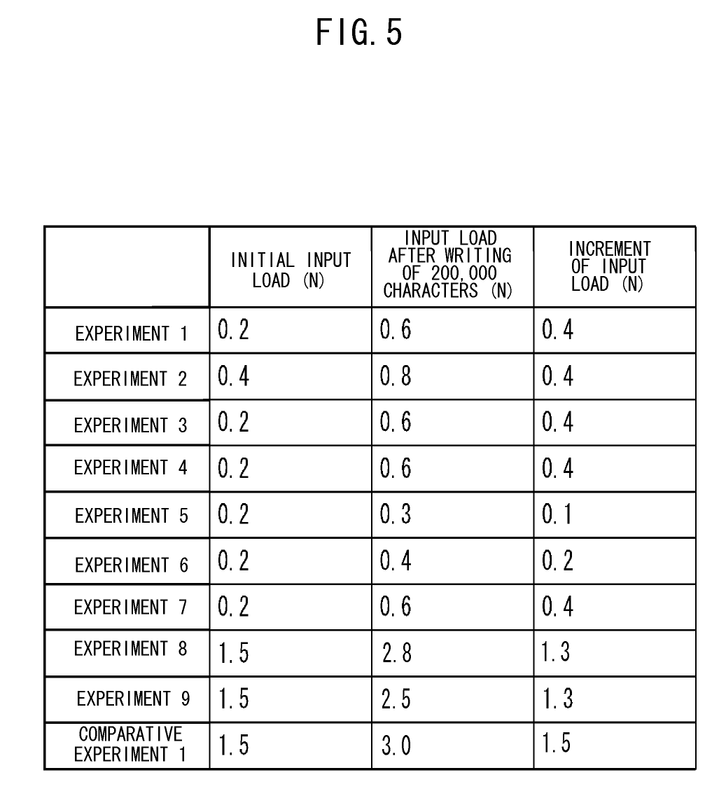

An experiment of the touch panel 1 was carried out by applying a load of 4.9 N to the touch panel 1 using a stylus which has a tip end of 0.8 R and continuously writing two hundred thousand characters. In the experiment, the minimum loads applied to the writing area at which a coordinate could be input by the pressing of the stylus were measured before and after the writing of two hundred thousand characters (hereinafter, referred to as the minimum input load measurement). The results of the measurement are shown in FIG. 5. The results confirmed that the increment of the minimum input load across the continuous writing of two hundred thousand characters was 0.4 N.

### (Experiment 2)

A touch panel 1 was made under the same condition as that of Experiment 1 except montmorillonite was added at 70 wt % as clay minerals contained in a transparent conductive film 12 of a resistance film 10.

The results of the minimum input load measurement are shown in FIG. 5. The results confirmed that, although the initial input load is slightly increased as compared to Experiment 1, the increment of the minimum input load across the continuous writing of two hundred thousand characters was 0.4 N.

### (Experiment 3)

A touch panel 1 was made under the same condition as that of Experiment 1 except montmorillonite was added at 50 wt % as clay minerals contained in a transparent conductive film 12 of a resistance film 10.

The results of the minimum input load measurement are shown in FIG. 5. The results confirmed that the increment of the minimum input load across the continuous writing of two hundred thousand characters was 0.4 N.

### (Experiment 4)

A touch panel 1 was made under the same condition as that of Experiment 1 except kaolinite was added, instead of clay minerals, to an organic transparent conductive film of a transparent conductive film 12 of a resistance film 10 at 30 wt %.

The results of the minimum input load measurement are shown in FIG. 5. The results confirmed that the increment of the minimum input load across the continuous writing of two hundred thousand characters was 0.4 N.

### (Experiment 5)

A touch panel 1 was made under the same condition as that of Experiment 1 except montmorillonite was added at 5 wt % as clay minerals contained in a transparent conductive film 12 of a resistance film 10, and a silane coupling agent was added to an organic transparent conductive film at 5 wt %.

The results of the minimum input load measurement are shown in FIG. 5. The results confirmed that the increment of the minimum input load across the continuous writing of two hundred thousand characters was 0.1 N.

### (Experiment 6)

A touch panel 1 was made under the same condition as that of Experiment 1 except montmorillonite was added at 1 wt % as clay minerals contained in a transparent conductive film 12 of a resistance film 10, and a silane coupling agent was added at 5 wt %, and a low molecular weight epoxy resin was also was added at 5 wt % to an organic transparent conductive film.

The results of the minimum input load measurement are shown in FIG. 5. The results confirmed that the increment of the minimum input load across the continuous writing of two hundred thousand characters was 0.2 N.

### (Experiment 7)

A touch panel 1 was made under the same condition as that of Experiment 1 except an ITO film having a surface resistivity of 1 kΩ/sq was used as a transparent conductive film 22 of a resistance film 20.

The results of the minimum input load measurement are shown in FIG. 5. The results confirmed that the increment of the minimum input load across the continuous writing of two hundred thousand characters was 0.4 N.

### (Experiment 8)

A touch panel 1 was made under the same condition as that of Experiment 1 except montmorillonite was added at 0.5 wt % as clay minerals contained in a transparent conductive film 12 of a resistance film 10.

The results of the minimum input load measurement are shown in FIG. 5. The results show that the increment of the minimum input load across the continuous writing of two hundred thousand characters was 1.3 N.

### (Experiment 9)

A touch panel 1 was made under the same condition as that of Experiment 1 except montmorillonite was added at 75 wt % as clay minerals contained in a transparent conductive film 12 of a resistance film 10.

The results of the minimum input load measurement are shown in FIG. 5. The results show that the increment of the minimum input load across the continuous writing of two hundred thousand characters was 1.3 N.

### (Comparative Experiment 1)

A touch panel 1 was made under the same condition as that of Experiment 1 except no clay minerals was added to the organic transparent conductive film which is a transparent conductive film of a resistance film 10.

The results of the minimum input load measurement are shown in FIG. 5. The results show that the increment of the minimum input load across the continuous writing of two hundred thousand characters was 1.5 N, and that the results were considerably worse as compared to those of Experiments 1 to 7. A delay of time was observed in the coordinate input apparatus.

As described above, in the touch panel, when no clay minerals were added to the organic transparent conductive film of the resistance film 10 (Comparative Experiment 1), the input load was considerably increased and a delay of time was observed. To the contrary, in the touch panel in which clay minerals were added to the organic transparent conductive film as in Experiments 1 to 9, an excellent result was obtained that the increment of the input load was remarkably smaller as compared to those in Comparative Experiments 1, and no delay of time was observed. Furthermore, when a silane coupling agent or a low molecular weight epoxy resin was added to the organic transparent conductive film in addition to clay minerals as in Experiments 5 and 6, a better result was obtained.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A coordinate input apparatus, comprising:
a pair of conductive films which are arranged opposite to each other for identifying a coordinate by a contact therebetween,
wherein at least one of the conductive films contains clay minerals.

2. The coordinate input apparatus according to claim 1, wherein
at least one of the conductive films is transparent.

3. The coordinate input apparatus according to claim 1, wherein
at least one of the conductive films is an organic conductive film.

4. The coordinate input apparatus according to claim 1, wherein
the clay minerals are added to the conductive film within a range of 1 wt % to 70 wt %, relative to a solid content concentration of the conductive film.

5. The coordinate input apparatus according to claim 1, wherein
the conductive film is formed of one or more materials selected from a group consisting of thiophene derivatives, polyaniline derivatives, and polypyrrole derivatives.

6. The coordinate input apparatus according to claim 1, wherein
the clay minerals are formed of one or more materials selected from a group consisting of montmorillonite, kaolinite, pyrophyllite, smectite, mica, chlorite, halloysite, allophane, imogolite, vermiculite, hectorite, gibbsitem and boehmiteone.

7. The coordinate input apparatus according to claim 1, wherein
the conductive film having the clay minerals contained therein further contains a silane coupling agent.

8. The coordinate input apparatus according to claim 7, wherein
the conductive film having the clay minerals contained therein contains an epoxy resin.

9. The coordinate input apparatus according to claim 7, wherein
the conductive film having the clay minerals contained therein contains an acrylic resin.

10. The coordinate input apparatus according to claim 1, wherein
the pair of conductive films have a contact resistance value of 10 kΩ or less.

11. The coordinate input apparatus according to claim 1, wherein
the pair of conductive films are formed on a supporting substrate which is made of a PET film or glass.

12. The coordinate input apparatus according to claim 1, wherein
the pair of conductive films are formed on a resin which has an ultraviolet blocking function.

13. The coordinate input apparatus according to claim 1, wherein
one of the pair of conductive films is an inorganic conductive film.

14. The coordinate input apparatus according to claim 13, wherein
the inorganic conductive film is formed of a material which contains ITO or ZnO.

15. The coordinate input apparatus according to claim 1, wherein
the pair of conductive films are separated from each other by a spacer.

16. The coordinate input apparatus according to claim 15, wherein
the spacer is a dot spacer.

17. An electrical device, comprising:
a coordinate input section having a pair of conductive films which are arranged opposite to each other for identifying a coordinate by a contact therebetween, with at least one of the conductive films containing clay minerals.

18. The electrical device according to claim 17, wherein
the coordinate input section is a touch panel.

19. The electrical device according to claim 18, wherein
the conductive film is formed of one or more materials selected from a group consisting of thiophene derivatives, polyaniline derivatives, and polypyrrole derivatives.

20. The electrical device according to claim 19, wherein
the clay minerals are formed of one or more materials selected from a group consisting of montmorillonite, kaolinite, pyrophyllite, smectite, mica, chlorite, halloysite, allophane, imogolite, vermiculite, hectorite, gibbsitem and boehmite.
